(19) United States
(12) Patent Application Publication
(10) Pub. No.: US 2019/0364868 A1
(43) Pub. Date: Dec. 5, 2019

(54) Flat-Tipped End Farrier Shears

(71) Applicant: Joshua Israel Garner, Grover Beach, CA (US)

(72) Inventor: Joshua Israel Garner, Grover Beach, CA (US)

(21) Appl. No.: 16/428,359

(22) Filed: May 31, 2019

Related U.S. Application Data
(60) Provisional application No. 62/680,075, filed on Jun. 4, 2018.

(51) Int. Cl. A01L 11/00; B26B 17/00

(52) U.S. Cl. CPC A01L 11/00; B26B 17/00

(57) ABSTRACT

A flat-tipped end farrier shears includes a first arm, a second arm, and a connector pin. The first arm that rotates about the connector pin includes a first handle, a first shoulder, and a first jaw. The second arm that rotates about the connector pin includes a second handle, a second shoulder, and a second jaw. The first handle and the first jaw are oppositely connected to each other through the first shoulder. The second handle and the second jaw are oppositely connected to each other through the second shoulder. The first and second shoulders are rotatably mounted to each other through the connector pin so that the first and second handles are able to apply pressure to the first and second jaws. A first shear-cutting edge of the first jaw is then positioned offset from a second shear-cutting edge of the second jaw thus shearing a nail head.

The current application claims a priority to the U.S. Provisional Patent application Ser. No. 62/680,075 filed on Jun. 4, 2018.

### FIELD OF THE INVENTION

The present invention relates generally farrier tools and the like. Specifically, the present invention is a horseshoe nail nipper, or the like, with flat-tipped ends to shear the heads of horseshoe nails in a flat and leveled fashion some distance off from the hoof wall of the animal.

### BACKGROUND OF THE INVENTION

In present society, there has been some advances in installing horseshoes of the hoof of horses, and the like. However, over the past years, the method behind installing horseshoes has not changed much. Although the method has not really differed much over the past years, there are several ways to improve the method. Firstly, the method is labor intensive and too time-consuming. The method requires that the farrier utilize a nail cutter and a hoof rasp. More specifically, after the nail is driven through the hoof (with a horseshoe attached) a farrier want to immediately fold the nail over or twist the nail off for the farrier's safety. Aforementioned folded or twisted nail is required to be cut to a length through the nail cutters so that the farrier can then lock the nail on by clinching the nail. During the clinching process of the nail, existing nail cutters tend to pinch and deform the nail thus leaving a peak that needs to be shave down the hoof wall. Therefore, the farrier has to utilize the hoof rasp to remove the peak from the nail. This process is often repeated until the nail is flush with the hoof wall. Since this process is often repeated until the job is completed, the user can become fatigued sooner than expected. Also, the user can find themselves having spent a lot time on repeating this process. Finally, because of the repeated nature of the method, the longevity of the hoof rasp is reduced since it is being used for the nail, which is made of metal, when it is intended for the hoof wall, which is made of keratin. What is required is a farrier tool that can reduce the time spent in shearing and flushing the head of the nail, while reducing the need of other farrier tools unrelated to the shearing and flushing of the head of the nail.

An objective of the present invention is to provide users with a horseshoe nail nipper, or the like, with flat-tipped ends to shear the heads of horseshoe nails in a flat and leveled fashion some distance off from the hoof wall of the animal. The present invention intends to eliminate the need to utilize both a nail nipper and a hoof rasp to produce in a flat and leveled surface that is parallel with the hoof wall and some distance off from the hoof wall in the head of the remaining nail. The present invention intends to provide users with a tool that eliminates the need to utilize a hoof rasp on the remaining nail portion. An objective of the present invention is to provide users with a farrier tool that reduces the amount of time spent or the number of steps taken in preparing the horseshoe attachment.

### SUMMARY OF THE INVENTION

The present invention is a horseshoe nail nipper, or the like, with flat-tipped ends to shear the heads of horseshoe nails in a flat and leveled fashion some distance off from the hoof wall of the animal. The present invention comprises a first arm and a second arm. The first arm comprises a first jaw. Likewise, the second arm comprises a second jaw. The first jaw ends with an upper prong-receiving indentation that is positioned slightly below a free end of the second jaw. The second jaw ends in a quadrilateral-like shaped face that is slightly off-set from a free end of the first jaw. The first handle and the second handle contain a pair of tool stoppers that is oriented towards each other.

### BRIEF DESCRIPTION OF THE DRAWINGS

FIG. 1 is a perspective view of the present invention.

FIG. 2 is a front view of the present invention.

FIG. 3 is a front view of the first arm of the present invention.

FIG. 4 is a front view of the second arm of the present invention.

FIG. 5 is an exploded perspective view of the present invention.

FIG. 6 is a detail view showing the height of the first shear-cutting edge being larger than the height of the second shear-cutting edge, and the free end of the second jaw being positioned within the upper prong-receiving indentation.

### DETAIL DESCRIPTIONS OF THE INVENTION

All illustrations of the drawings are to be describing selected versions of the present invention and are not intended to limit the scope of the present invention. All references of user or users pertain to individual or individuals who would utilize the present invention. All references of nail or nails can pertain to horseshoe nails, other animal hoofs, and other similar objects. All references of hoof or hoofs can pertain to horse hoofs, other animal hoofs, and other similar objects.

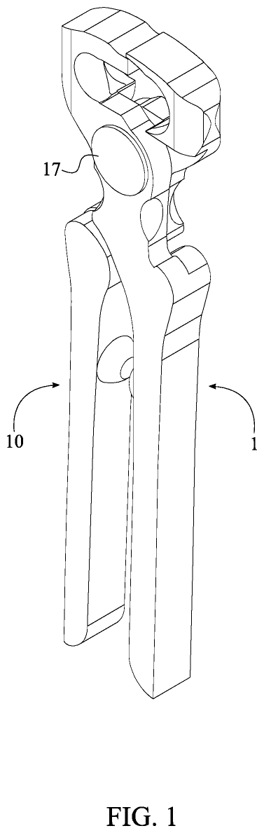

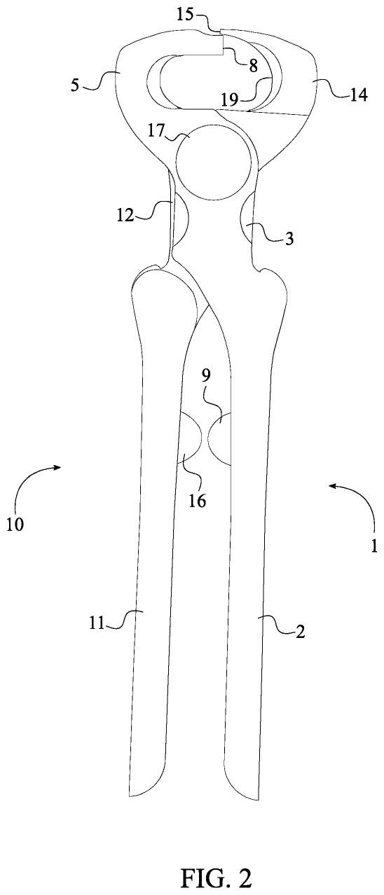

In reference to FIG. 1-2, the present invention is a horseshoe nail nipper, or the like, to shear the heads of nails in a flat and leveled fashion with a minimum distance off from the hoof wall. The present invention can be of any shape, size, material, features, type or kind, orientation, and arrangements of components that would allow the present invention to fulfill the objectives and intents of the present invention. However, it is preferred that the present invention be of a material that is strong, durable, stiff, easily manufacturable, impact-resistant, lightweight, compatible and safe with hoof and/or nail, and/or penetrable. Such a material could include, but is not limited to, the following: steel, iron, titanium, and/or other similar metals. It can be preferred that the present invention be of a general shape and size similar to other farrier tools similar to the present invention.

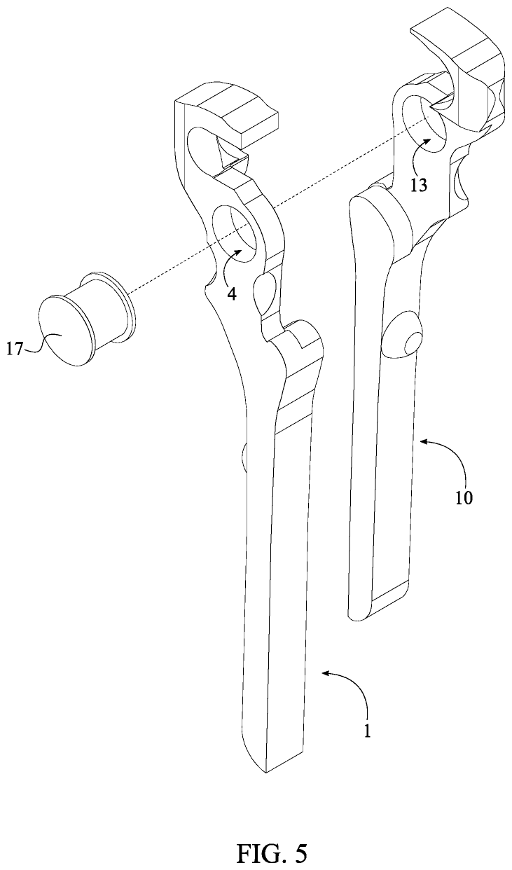

The present invention comprises a first arm 1, a second arm 10, a connector pin 17 as shown in FIG. 1-2 and FIG. 5. In reference to the general configuration, the first arm 1 and the second arm 10 are rotatably connected to each other through the connector pin 17 thus resembling the functionality and the appearance of a nail nipper. The first arm 1 that functions as a leverage support arm comprises a first handle 2, a first shoulder 3, and a first jaw 5. Resultantly, the first handle 2 and the first jaw 5 are oppositely connected to each other through the first shoulder 3 so that the first arm 1 can function as an elongated body within the present invention. The second arm 10 also functions as a leverage support arm and comprises a second handle 11, a second shoulder 12, and a second jaw 14. Resultantly, the second handle 11 and the second jaw 14 are oppositely connected to each other through the second shoulder 12 so that the second arm 10 can function as an elongated body within the present invention. It is also preferred that the first arm 1 be similar or identical to the second arm 10 in general shape. The first shoulder 3 and the second shoulder 12 are rotatably mounted to each other through the connector pin 17 thus enabling the functionality of the present invention. For example, when the first handle 2 and the second handle 11 are push towards each other, the first jaw 5 and the second jaw 14 are pressed against each due to the engagement of the connector pin 17. Then, present invention is able to successfully transfer applied power of the first handle 2 and the second handle 11 to a first shear-cutting edge 8 of the first jaw 5 and a second shear-cutting edge 15 of the second jaw 14. As a result, the first shear-cutting edge 8 is positioned offset from the second shear-cutting edge 15 in such a way that the second shear-cutting edge 15 glides over the first shear-cutting edge 8. In other words, pressing action of the first handle 2 and the second handle 11 towards each other converts the present invention into a closed or cinched position thus enabling shearing of the nail head.

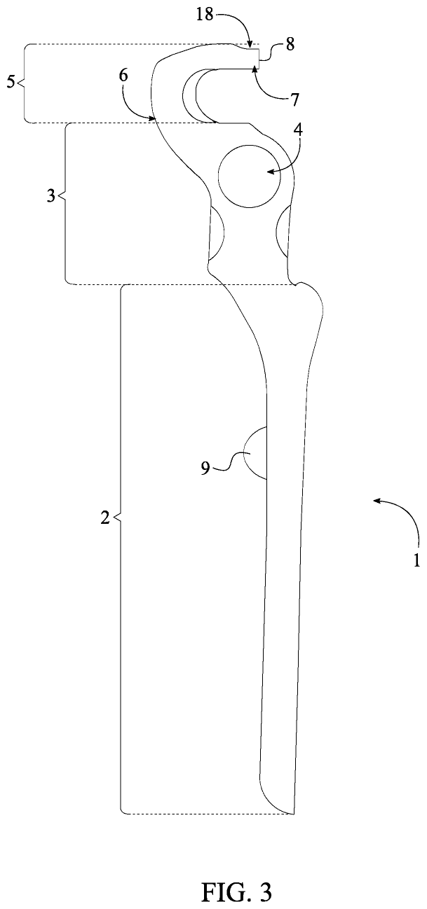

The first arm 1 is preferably shaped into an elongated, slender shape commonly found in some farrier tools like clinchers, nippers, and the like. In reference to FIG. 3, the first handle 2 that provides surface area to grasp and apply pressure is terminally connected to the first shoulder 3. The first handle 2 may also configure into an ergonomic shape to improve user comfort during usage. The first shoulder 3 provides the necessary surface to engage with the second arm 10 so that the maximum and minimum rotational boundaries of the first arm 1 can be defined in response to positioning of the second arm 10. The first jaw 5 is preferably shaped into a C-shaped body, wherein one end of the C-shaped body is connected to the first shoulder 3, and the other end of the C-shaped body functions as the nail nipper. More specifically, a fixed end 6 of the first jaw 5 is terminally connected to the first shoulder 3, opposite of the first handle 2. A free end 7 of the first jaw 5 is oppositely positioned of the fixed end 6 of the first jaw 5, along the first jaw 5. The first shear-cutting edge 8 that presses against the nail head is terminally positioned on the first jaw 5 and positioned opposite of the first shoulder 3.

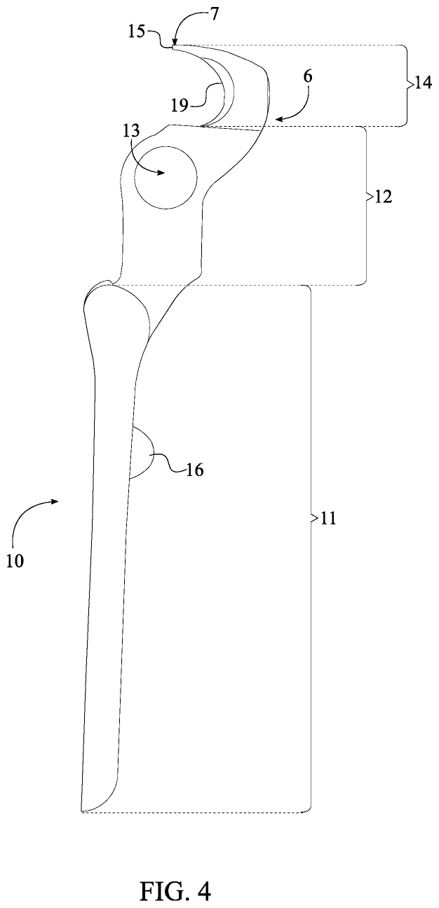

The second arm 10 is preferably shaped into an elongated, slender shape commonly found in some farrier tools like clinchers, nippers, and the like. In reference to FIG. 4, the second handle 11 that provides surface area to grasp and apply pressure is terminally connected to the second shoulder 12. The second handle 11 may also configure into an ergonomic shape to improve user comfort during usage. The second shoulder 12 provides the necessary surface to engage with the first arm 1 so that the maximum and minimum rotational boundaries of the second arm 10 can be defined in response to positioning of the first arm 1. The second jaw 14 is preferably shaped into a C-shaped body, wherein one end of the C-shaped body is connected to the second shoulder 12, and the other end of the C-shaped body functions as the nail nipper. More specifically, a fixed end 6 of the second jaw 14 is terminally connected to the second shoulder 12, opposite of the second handle 11. A free end 7 of the second jaw 14 is oppositely positioned of the fixed end 6 of the second jaw 14, along the end of the second jaw 14. The second shear-cutting edge 15 that presses against the nail head is terminally positioned on the first jaw 5 and positioned opposite of the first shoulder 3.

In reference to FIG. 3-5, the first arm 1 further comprises a first opening 4, and the second arm 10 further comprises a second opening 13. The first opening 4 and the second opening 13 are generally identical to each other so that the connector pin 17 can traverse through the first opening 4 and the second opening 13. More specifically, the first opening 4 traverses through the first shoulder 3 and positioned proximal to the first jaw 5. The second opening 13 traverses through the second shoulder 12 and positioned proximal to the second jaw 14. The connector pin 17 is concentrically engaged with the first opening 4 and the second opening 13 thus enabling the rotational movement of the first arm 1 and the second arm 10 about the connector pin 17.

In reference to FIG. 2, the present invention further comprises a first stopper 9 and a second stopper 16. The first stopper 9 and the second stopper 16 are preferably formed into a hemispherical-like shaped body and functions as a barrier so that the first handle 2 and the second handle 11 can be stopped parallel to each other. More specifically, the first stopper 9 is adjacently connected to the first handle 2 in such a way that the first stopper 9 orients toward the second handle 11. The second stopper 16 is adjacently connected to the second handle 11 in such a way that the second stopper 16 orients toward the first handle 2. As a result, when the first handle 2 and the second handle 11 are pressed together, the first stopper 9 and the second stopper 16 are pressed against each other thus maintaining a parallel positioning for the first handle 2 and the second handle 11.

The present invention further comprises an upper prong-receiving indentation 18 that provides an empty area within the first jaw 5 as shown in FIG. 3. More specifically, the upper prong-receiving indentation 18 is integrated into the free end 7 of the first jaw 5 so that the free end 7 of the second jaw 14 can slide into the upper prong-receiving indentation 18. In other words, the second shear-cutting edge 15 is positioned atop the upper prong-receiving indentation 18 and is slightly offset from the first shear-cutting edge 8.

The present invention further comprises an inner concave surface 19 as shown in FIG. 2. More specifically, the inner concave surface 19 is internally extended from the free end 7 of the second jaw 14 to the fixed end 6 of the second jaw 14 so that the free end 7 of the first jaw 5 can slide adjacent to the inner concave surface 19. In other words, the first shear-cutting edge 8 is positioned adjacent to the inner concave surface 19 about the free end 7 of the second jaw 14.

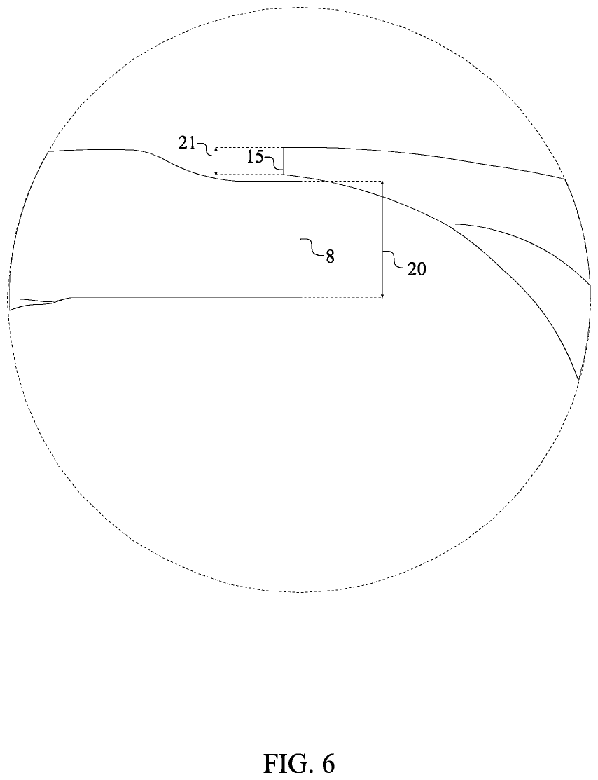

Generally, after the nail is driven through the hoof (with a horseshoe attached) a farrier want to immediately fold the nail over or twist the nail off for the farrier's safety. Aforementioned folded or twisted nail is required to be cut to a length so that the farrier can then lock the nail on by clinching the nail. During the clinching process of the nail, existing nail cutters tend to pinch and deform the nail thus leaving a peak that needs to be rasped square. The present invention is able to shear the twisted or folded nail square thus leaving a minimum distance off from the hoof wall. Resultantly, the present invention is able to eliminate the rasping process as the remaining length of the nail does not leave a peak and not a safety issue. When the present invention is at the closed or cinched position, the engagement between the first shear-cutting edge 8 and the second shear-cutting edge 15 about the upper prong-receiving indentation 18 is able to shear the nail head in a flat and level fashion with a minimum distance off from the hoof wall. The remaining length of the nail is generally equal to a depth of the upper prong-receiving indentation 18 as the outer surface of the first jaw 5 and the second jaw 14 glide along the hoof wall during the shearing of the nail head. In order to cleanly and efficiently shear the nail head, a height 20 of the first shear-cutting edge 8 is required to be larger than a height 21 of the second shear-cutting edge 15 as shown in FIG. 6. As a result, the first shear-cutting edge 8 is able to provide a backing for the nail while the second shear-cutting edge 15 is able to shear the nail head. In order to attain the aforementioned minimum distance off from the hoof wall for the nail, the height of the second shear-cutting edge 15 is about equal to the depth of the upper prong-receiving indentation 18 so that the second shear-cutting edge 15 is able to push the remaining length of the nail into the upper prong-receiving indentation 18 after the nail head is being sheared.

Although the invention has been explained in relation to its preferred embodiment, it is to be understood that many other possible modifications and variations can be made without departing from the spirit and scope of the invention as hereinafter claimed.

What is claimed is:

1. A flat-tipped end farrier shears comprising:
a first arm;
a second arm;
a connector pin;
the first arm comprises a first handle, a first shoulder, and a first jaw;
the second arm comprises a second handle, a second shoulder, and a second jaw;
the first handle and the first jaw being oppositely connected to each other through the first shoulder;
the second handle and the second jaw being oppositely connected to each other through the second shoulder;
the first shoulder and the second shoulder being rotatably mounted to each other through the connector pin; and
a first shear-cutting edge of the first jaw being positioned offset from a second shear-cutting edge of the second jaw.

2. The flat-tipped end farrier shears as claimed in claim 1 comprising:
the first handle being terminally connected to the first shoulder;
a fixed end of the first jaw being terminally connected to the first shoulder, opposite of the first handle;
a free end of the first jaw being oppositely positioned of the fixed end of the first jaw, along the first jaw; and
the first shear-cutting edge being terminally positioned on the first jaw, opposite of the first shoulder.

3. The flat-tipped end farrier shears as claimed in claim 1 comprising:
the second handle being terminally connected to the second shoulder;
a fixed end of the second jaw being terminally connected to the second shoulder, opposite of the second handle;
a free end of the second jaw being oppositely positioned of the fixed end of the second jaw, along the second jaw; and
the second shear-cutting edge being terminally positioned on the second jaw, opposite of the second shoulder.

4. The flat-tipped end farrier shears as claimed in claim 1 comprising:
the first arm further comprises a first opening;
the second arm further comprises a second opening;
the first opening traversing through the first shoulder;
the second opening traversing through the second shoulder; and
the connector pin being concentrically engaged with the first opening and the second opening.

5. The flat-tipped end farrier shears as claimed in claim 1 comprising:
a first stopper;
the first stopper being adjacently connected to the first handle; and
the first stopper being oriented toward the second handle.

6. The flat-tipped end farrier shears as claimed in claim 1 comprising:
a second stopper;
the second stopper being adjacently connected to the second handle; and
the second stopper being oriented toward the first handle.

7. The flat-tipped end farrier shears as claimed in claim 1 comprising:
an upper prong-receiving indentation;
the upper prong-receiving indentation being integrated into a free end of the first jaw; and
the second shear-cutting edge being positioned atop the upper prong-receiving indentation.

8. The flat-tipped end farrier shears as claimed in claim 1 comprising:
an inner concave surface;
the inner concave surface being internally extended from a free end of the second jaw to a fixed end of the second jaw; and
the first shear-cutting edge being positioned adjacent to the inner concave surface, about the free end of the second jaw.

9. The flat-tipped end farrier shears as claimed in claim 1, wherein a height of the first shear-cutting edge larger than a height of the second shear-cutting edge.

10. A flat-tipped end farrier shears comprising:
a first arm;
a second arm;
a connector pin;
an upper prong-receiving indentation;
the first arm comprises a first handle, a first shoulder, and a first jaw;
the second arm comprises a second handle, a second shoulder, and a second jaw;
the first handle and the first jaw being oppositely connected to each other through the first shoulder;
the second handle and the second jaw being oppositely connected to each other through the second shoulder;
the first shoulder and the second shoulder being rotatably mounted to each other through the connector pin;
the upper prong-receiving indentation being integrated into a free end of the first jaw;
a first shear-cutting edge of the first jaw being positioned offset from a second shear-cutting edge of the second jaw; and
the second shear-cutting edge being positioned atop the upper prong-receiving indentation.

11. The flat-tipped end farrier shears as claimed in claim 10 comprising:
the first handle being terminally connected to the first shoulder;
a fixed end of the first jaw being terminally connected to the first shoulder, opposite of the first handle;
the free end of the first jaw being oppositely positioned of the fixed end of the first jaw, along the first jaw; and
the first shear-cutting edge being terminally positioned on the first jaw, opposite of the first shoulder.

12. The flat-tipped end farrier shears as claimed in claim 10 comprising:
the second handle being terminally connected to the second shoulder;
a fixed end of the second jaw being terminally connected to the second shoulder, opposite of the second handle;
a free end of the second jaw being oppositely positioned of the fixed end of the second jaw, along the second jaw; and
the second shear-cutting edge being terminally positioned on the second jaw, opposite of the second shoulder.

13. The flat-tipped end farrier shears as claimed in claim 10 comprising:
the first arm further comprises a first opening;
the second arm further comprises a second opening;
the first opening traversing through the first shoulder;
the second opening traversing through the second shoulder; and
the connector pin being concentrically engaged with the first opening and the second opening.

14. The flat-tipped end farrier shears as claimed in claim 10 comprising:
a first stopper;
the first stopper being adjacently connected to the first handle; and
the first stopper being oriented toward the second handle.

15. The flat-tipped end farrier shears as claimed in claim 10 comprising:
a second stopper;
the second stopper being adjacently connected to the second handle; and
the second stopper being oriented toward the first handle.

16. The flat-tipped end farrier shears as claimed in claim 10 comprising:
an inner concave surface;
the inner concave surface being internally extended from a free end of the second jaw to a fixed end of the second jaw; and
the first shear-cutting edge being positioned adjacent to the inner concave surface, about the free end of the second jaw.

17. The flat-tipped end farrier shears as claimed in claim 10, wherein a height of the first shear-cutting edge larger than a height of the second shear-cutting edge.
